(19) United States
(12) Patent Application Publication
(10) Pub. No.: US 2016/0379123 A1
(43) Pub. Date: Dec. 29, 2016

(54) Entertainment Prediction Favorites

(71) Applicant: Comcast Cable Communications, LLC, Philadelphia, PA (US)

(72) Inventors: Ehsan Younessian, Washington, DC (US); Brian Curtis, Washington, DC (US); Hassan Sayyadi-Harikandehei, Washington, DC (US)

(21) Appl. No.: 14/749,141

(22) Filed: Jun. 24, 2015

(51) Int. Cl. G06N 5/04; G06F 17/30

(52) U.S. Cl. CPC G06N 5/04; G06F 17/3053

(57) ABSTRACT

Systems and methods are described for generating recommendations for content items and ranking categories of content based on a user's consumption history. The content items may comprise various forms of media content, including, video, audio, Internet webpages, etc. When a user or consumption device accesses content items, a computing device may monitor the amount of the content items consumed by a user over one or more consumption sessions. In one embodiment, a user may identify content preferences and/or provide other input to the recommendation system to further customize content rankings and recommendations.

### BACKGROUND

Current methods of predicting user entertainment and/or content favorites can be complicated and generate inaccurate results. With the proliferation of content made available for consumption, it has become exceedingly difficult to efficiently locate meaningful content. The flexibility and precision offered by content recommendation systems can be beneficial, as such, there remains an ever-present need for improved and simplified ways to identify relevant content for users.

### SUMMARY

The following summary is for illustrative purposes only, and is not intended to limit or constrain the detailed description. The following summary merely presents various described aspects in a simplified form as a prelude to the more detailed description provided below.

Features herein relate to a content recommendation system and methods that may be used as a stand-alone recommendation system or comprise a portion of another recommendation system. The content recommendation system may be based on a user's previous content consumption history. According to one aspect of the disclosure herein, a user may request and/or consume a plurality of content items made available by a content provider. These content items may be transmitted from a content provider's server to one or more consumption or access devices associated with a user. Additionally, or alternatively, the content items may be transmitted from a data processing facility, such as a local office, to the user for consumption. The amount of content consumed by a user and other information relating to said content may be tracked and recorded by a content provider's and/or a third-party's computing device, which may be disposed at the local office or another location. Additionally or alternatively, a user's consumption behavior may be monitored by one or more of the user's consumption or access devices.

A user's content consumption history and other related information may be processed by the content recommendation system to generate content rankings, implicit user favorites, and/or content recommendations for the user. Additionally, a user may identify particular content preferences and/or provide other information input to the recommendation system to further customize said rankings, favorites, and content recommendations. For example, the user may identify a particular category of content for which the user desires to receive a content recommendation, determine implicit favorites and/or rankings from the recommendation system.

The content recommendation system may determine (and/or assign) scores to one or more elements of a content category being ranked (or analyzed) by the system based at least in part upon the content consumption history of a user. The content recommendation system may be further configured to determine (and/or disregard) extraneous content information within the user's content consumption history that may not be considered by the system when determining content recommendation, rankings, or user favorites. The content recommendation system may determine a user's favorite type of content (e.g., favorite sports teams, favorite actors, favorite genres of movies, etc.) based on the user's content consumption history. The content recommendation system may generate content recommendations for the user based on various types of information, such as user profile preferences, content rankings and/or user favorites determined by the system for the user. In some aspects of the present disclosure, the content recommendation system may utilize an iterative algorithm including multiple rounds of scoring to rank content category elements, determine implicit favorites, and generate content recommendations for a user.

The summary here is not an exhaustive listing of the novel features described herein, and are not limiting of the claims. These and other features are described in greater detail below.

### BRIEF DESCRIPTION OF THE DRAWINGS

These and other features, aspects, and advantages of the present disclosure will become better understood with regard to the following description, claims, and drawings. The present disclosure is illustrated by way of example, and not limited by, the accompanying figures in which like numerals indicate similar elements.

FIG. 1 illustrates an example communication network on which various features described herein may be used.

FIG. 2 illustrates an example computing device that can be used to implement any of the methods, servers, entities, and computing devices described herein.

FIGS. 3A-C illustrate exemplary flowcharts of a process for determining implicit user favorites according to one or more illustrative aspects of the disclosure.

FIGS. 4A-E illustrate example user interfaces according to one or more illustrative aspects of the disclosure.

FIGS. 5A-D illustrate exemplary diagrams and rankings associated with a process for determining user favorites according to one or more illustrative aspects of the disclosure.

FIGS. 6A-C illustrate exemplary diagrams and rankings associated with a process for determining user favorites according to one or more illustrative aspects of the disclosure

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

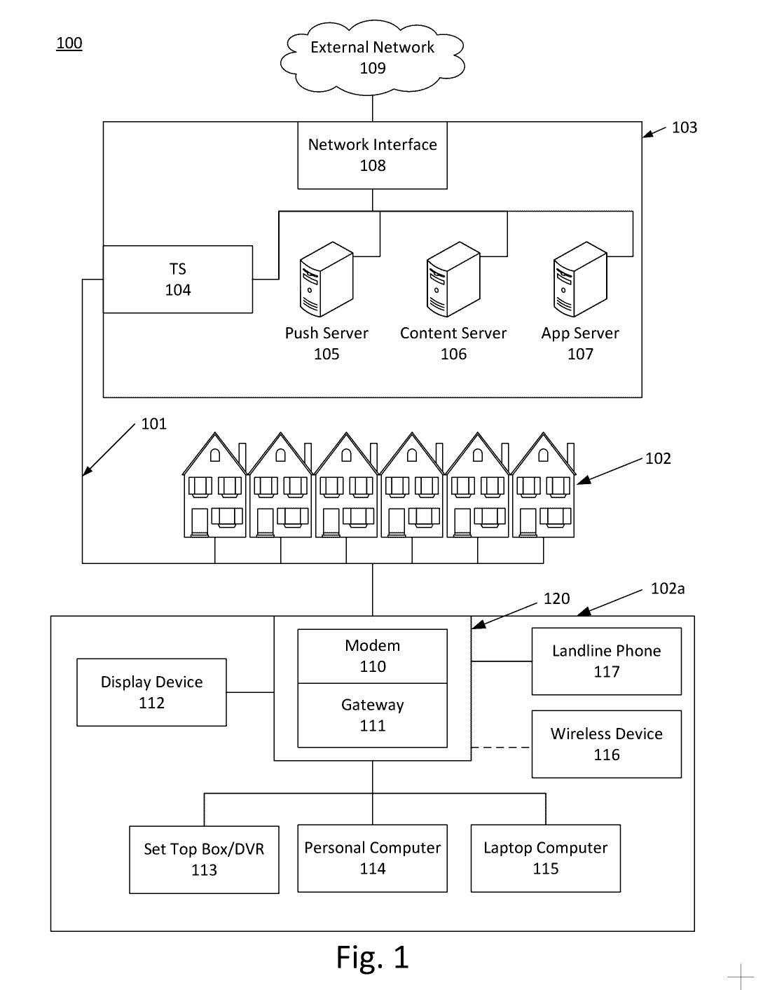

FIG. 1 illustrates an example communication network 100 on which many of the various features described herein may be implemented. Network 100 may be any type of information distribution network, such as satellite, telephone, cellular, wireless, etc. One example may be an optical fiber network, a coaxial cable network, or a hybrid fiber/coax distribution network. Such networks 100 use a series of interconnected communication links 101 (e.g., coaxial cables, optical fibers, wireless, etc.) to connect multiple premises 102 (e.g., businesses, homes, user dwellings, etc.) to a local office or headend 103. The local office 103 may transmit downstream information signals onto the links 101, and one or more premises 102 may have a receiver used to receive and process those signals.

There may be one link 101 originating from the local office 103, and it may be split a number of times to distribute the signal to various premises 102 in the vicinity (which may be many miles) of the local office 103. The links 101 may include components not illustrated, such as splitters, filters, amplifiers, etc. to help convey the signal clearly, but in general each split introduces a bit of signal degradation. Portions of the links 101 may also be implemented with fiber-optic cable, while other portions may be implemented with coaxial cable, other lines, or wireless communication paths. By running fiber optic cable along some portions, for example, signal degradation may be significantly minimized, allowing a single local office 103 to reach even farther with its network of links 101 than before.

The local office 103 may include an interface, such as a termination system (TS) 104. More specifically, the interface 104 may be a cable modem termination system (CMTS), which may be a computing device configured to manage communications between devices on the network of links 101 and backend devices such as servers 105-107 (to be discussed further below). The interface 104 may be as specified in a standard, such as the Data Over Cable Service Interface Specification (DOCSIS) standard, published by Cable Television Laboratories, Inc. (a.k.a. CableLabs), or it may be a similar or modified device instead. The interface 104 may be configured to place data on one or more downstream frequencies to be received by modems at the various premises 102, and to receive upstream communications from those modems on one or more upstream frequencies.

The local office 103 may also include one or more network interfaces 108, which can permit the local office 103 to communicate with various other external networks 109. These networks 109 may include, for example, networks of Internet devices, telephone networks, cellular telephone networks, fiber optic networks, local wireless networks (e.g., WiMAX), satellite networks, and any other desired network, and the network interface 108 may include the corresponding circuitry needed to communicate on the external networks 109, and to other devices on the network such as a cellular telephone network and its corresponding cell phones.

As noted above, the local office 103 may include a variety of servers 105-107 that may be configured to perform various functions. For example, the local office 103 may include a push notification server 105. The push notification server 105 may generate push notifications to deliver data and/or commands to the various premises 102 in the network (or more specifically, to the devices in the premises 102 that are configured to detect such notifications). The local office 103 may also include a content server 106. The content server 106 may be one or more computing devices that are configured to provide content to users at their premises. This content may be, for example, video on demand movies, television programs, songs, text listings, etc. The content server 106 may include software to validate user identities and entitlements, to locate and retrieve requested content, to encrypt the content, and to initiate delivery (e.g., streaming) of the content to the requesting user(s) and/or device(s).

The local office 103 may also include one or more application servers 107. An application server 107 may be a computing device configured to offer any desired service, and may run various languages and operating systems (e.g., servlets and JSP pages running on Tomcat/MySQL, OSX, BSD, Ubuntu, Redhat, HTML5, JavaScript, AJAX and COMET). For example, an application server may be responsible for collecting television program listings information and generating a data download for electronic program guide listings. In some aspects of the disclosure, application server 107 may be responsible for monitoring user viewing habits and collecting that information for use in selecting advertisements. In other embodiments, application server 107 may be responsible for formatting and inserting advertisements in a video stream being transmitted to the premises 102. Although shown separately, one of ordinary skill in the art will appreciate that the push server 105, content server 106, and application server 107 may be combined. Further, here the push server 105, content server 106, and application server 107 are shown generally, and it will be understood that they may each contain memory storing computer executable instructions to cause a processor to perform steps described herein and/or memory for storing data.

An example premises 102a, such as a home, may include an interface 120. The interface 120 can include any communication circuitry needed to allow a device to communicate on one or more links 101 with other devices in the network. For example, the interface 120 may include a modem 110, which may include transmitters and receivers used to communicate on the links 101 and with the local office 103. The modem 110 may be, for example, a coaxial cable modem (for coaxial cable lines 101), a fiber interface node (for fiber optic lines 101), twisted-pair telephone modem, cellular telephone transceiver, satellite transceiver, local wi-fi router or access point, or any other desired modem device. Also, although only one modem is shown in FIG. 1, a plurality of modems operating in parallel may be implemented within the interface 120. Further, the interface 120 may include a gateway interface device 111. The modem 110 may be connected to, or be a part of, the gateway interface device 111. The gateway interface device 111 may be a computing device that communicates with the modem(s) 110 to allow one or more other devices in the premises 102a, to communicate with the local office 103 and other devices beyond the local office 103. The gateway interface device 111 may be a set-top box (STB), digital video recorder (DVR), computer server, or any other desired computing device. The gateway interface device 111 may also include (not shown) local network interfaces to provide communication signals to requesting entities/devices in the premises 102a, such as display devices 112 (e.g., televisions), additional STBs or DVRs 113, personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA), etc.), landline phones 117 (e.g. Voice over Internet Protocol—VoIP phones), and any other desired devices. Examples of the local network interfaces include Multimedia Over Coax Alliance (MoCA) interfaces, Ethernet interfaces, universal serial bus (USB) interfaces, wireless interfaces (e.g., IEEE 802.11, IEEE 802.15), analog twisted pair interfaces, Bluetooth interfaces, and others.

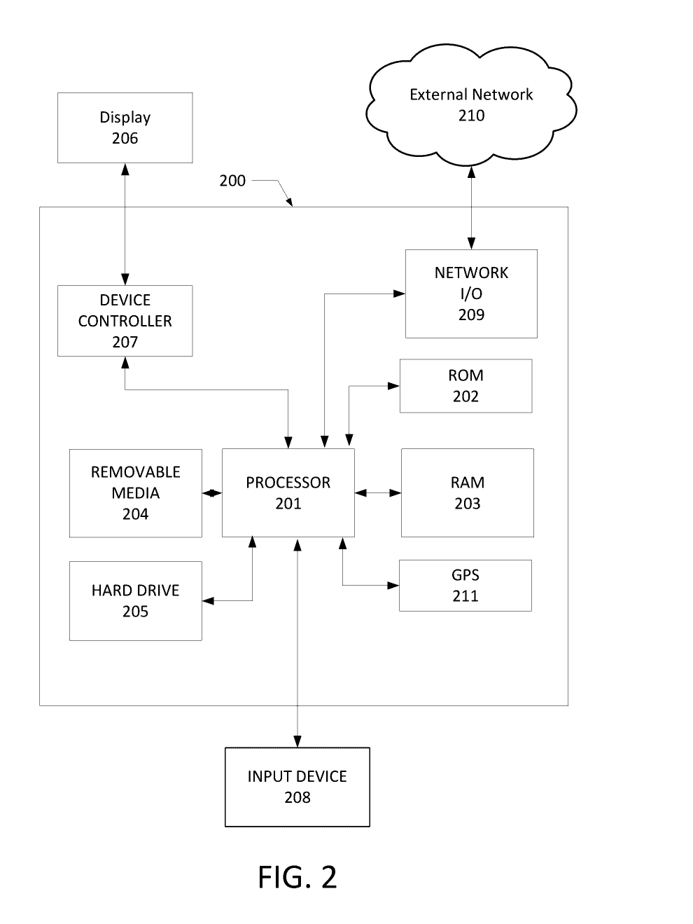

FIG. 2 illustrates general hardware elements that can be used to implement any of the various computing devices discussed herein. The computing device 200 may include one or more processors 201, which may execute instructions of a computer program to perform any of the features described herein. The instructions may be stored in any type of computer-readable medium or memory, to configure the operation of the processor 201. For example, instructions may be stored in a read-only memory (ROM) 202, random access memory (RAM) 203, removable media 204, such as a Universal Serial Bus (USB) drive, compact disk (CD) or digital versatile disk (DVD), floppy disk drive, or any other desired storage medium. Instructions may also be stored in an attached (or internal) hard drive 205. The computing device 200 may include one or more output devices, such as a display 206 (e.g., an external television), and may include one or more output device controllers 207, such as a video processor. There may also be one or more user input devices 208, such as a remote control, keyboard, mouse, touch screen, microphone, etc. The computing device 200 may also include one or more network interfaces, such as a network input/output (I/O) circuit 209 (e.g., a network card) to communicate with an external network 210. The network input/output circuit 209 may be a wired interface, wireless interface, or a combination of the two. In some embodiments, the network input/output circuit 209 may include a modem (e.g., a cable modem), and the external network 210 may include the communication links 101 discussed above, the external network 109, an in-home network, a provider's wireless, coaxial, fiber, or hybrid fiber/coaxial distribution system (e.g., a DOCSIS network), or any other desired network. Additionally, the device may include a location-detecting device, such as a global positioning system (GPS) microprocessor 211, which can be configured to receive and process global positioning signals and determine, with possible assistance from an external server and antenna, a geographic position of the device.

The FIG. 2 example is a hardware configuration, although the illustrated components may be implemented as software as well. Modifications may be made to add, remove, combine, divide, etc. components of the computing device 200 as desired. Additionally, the components illustrated may be implemented using basic computing devices and components, and the same components (e.g., processor 201, ROM storage 202, display 206, etc.) may be used to implement any of the other computing devices and components described herein. For example, the various components herein may be implemented using computing devices having components such as a processor executing computer-executable instructions stored on a computer-readable medium, as illustrated in FIG. 2. Some or all of the entities described herein may be software based, and may co-exist in a common physical platform (e.g., a requesting entity can be a separate software process and program from a dependent entity, both of which may be executed as software on a common computing device).

One or more aspects of the disclosure may be embodied in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the disclosure, and such data structures are contemplated within the scope of computer executable instructions and computer-usable data described herein.

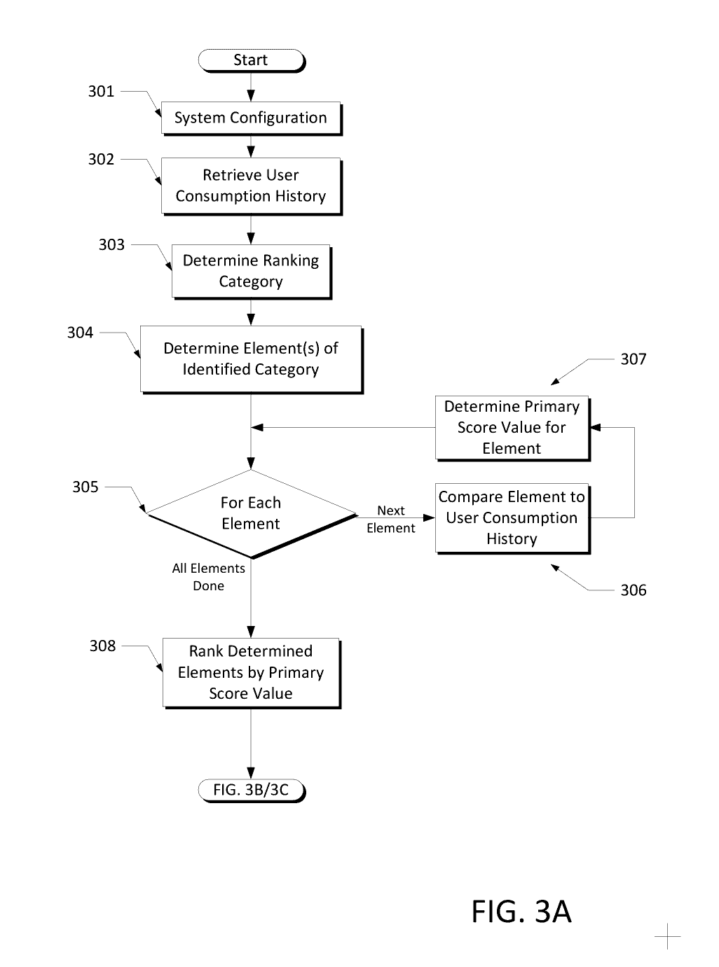

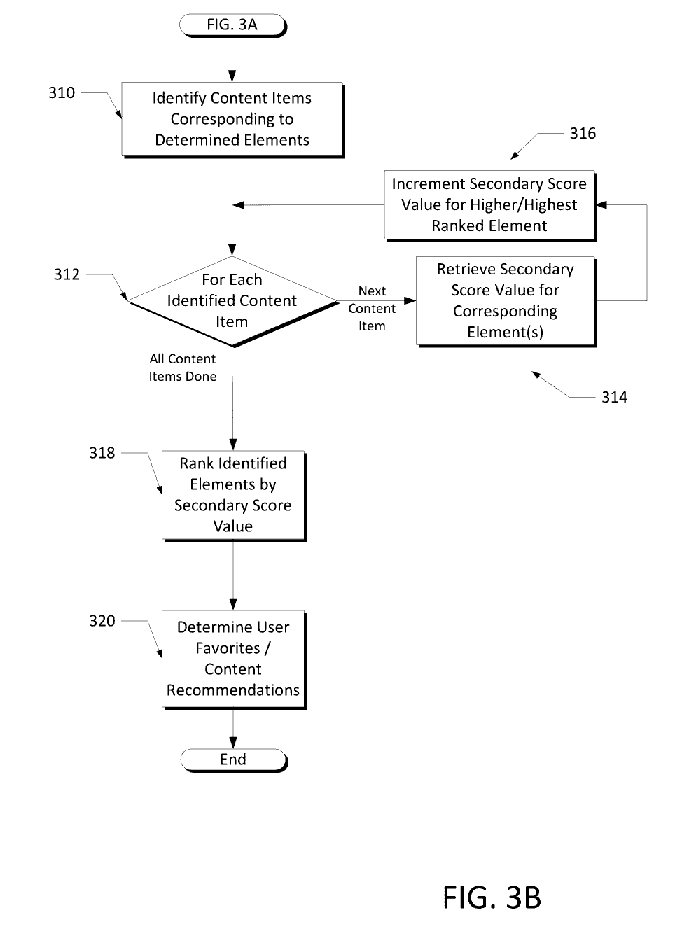

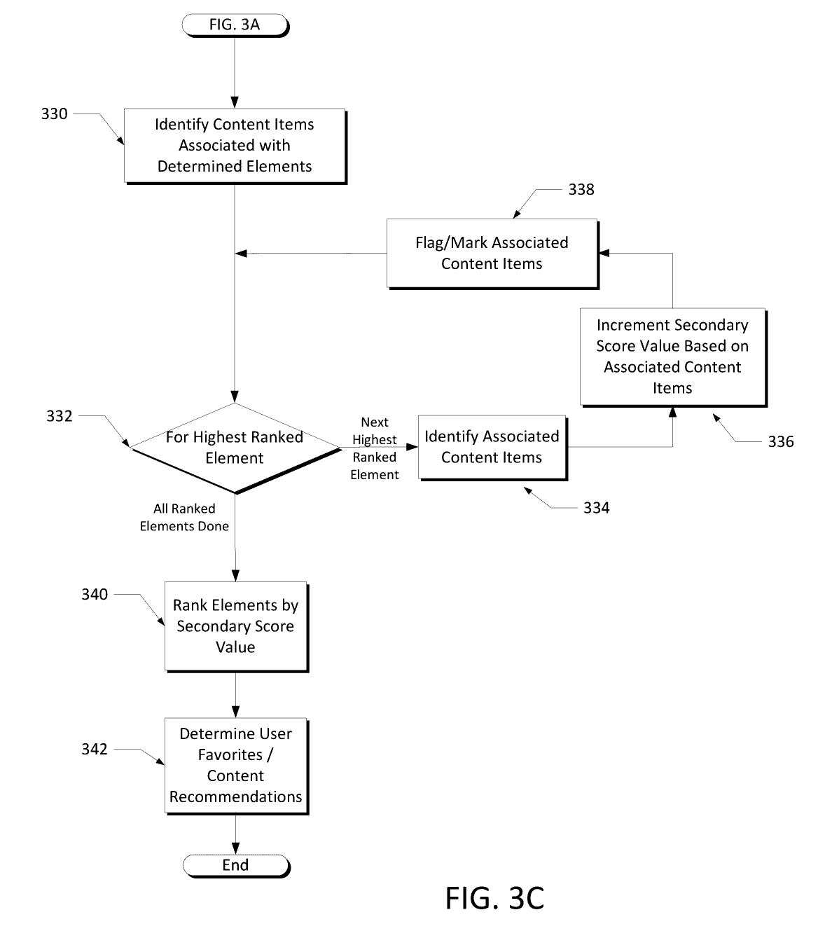

FIGS. 3A-C are diagrams illustrating example methods of determining content favorites for a user according to one or more illustrative aspects of the disclosure. The results of the content predictions may be implemented on their own by a content recommendation system to suggest content to a user, or may be combined with other recommendation systems and entertainment program guides. The steps illustrated in FIG. 3A-C may be performed by a content recommendation system, for example, by one or more computing devices at the local office 103, such as content server 106. The steps may also be implemented by a distributed computing system, having devices at various locations. One or more computing devices may be implemented as a computing device using the structure shown in FIG. 2, and may be configured to respond to user requests for content, such as streaming video or audio. For example, the content recommendation system may provide video on demand services, and may deliver streaming media, such as sport exhibitions, movies, television shows, radio programs and Internet videos and/or audio, to a user's consumption or access device (e.g., display device 112, gateway interface device 111, personal computer 114, wireless device 116, etc.), or any other desired computing device. For brevity, the following description will generally assume that the steps illustrated in FIGS. 3A-C are performed by the content recommendation system, which may include one or more provider or third-party computing devices, which may be disposed at local office 103 or other locations.

In step 301, the content recommendation system may be configured to perform various system configuration steps. This configuration process may include registering a user's consumption or access device with a content provider. For example, this registration step may include receiving information (e.g., a username, password, device ID, etc.) for setting up a user account with a content provider. When setting up a user account, a user may specify user and/or device preferences that may determine, at least partially, which content items are subsequently provided to the user.

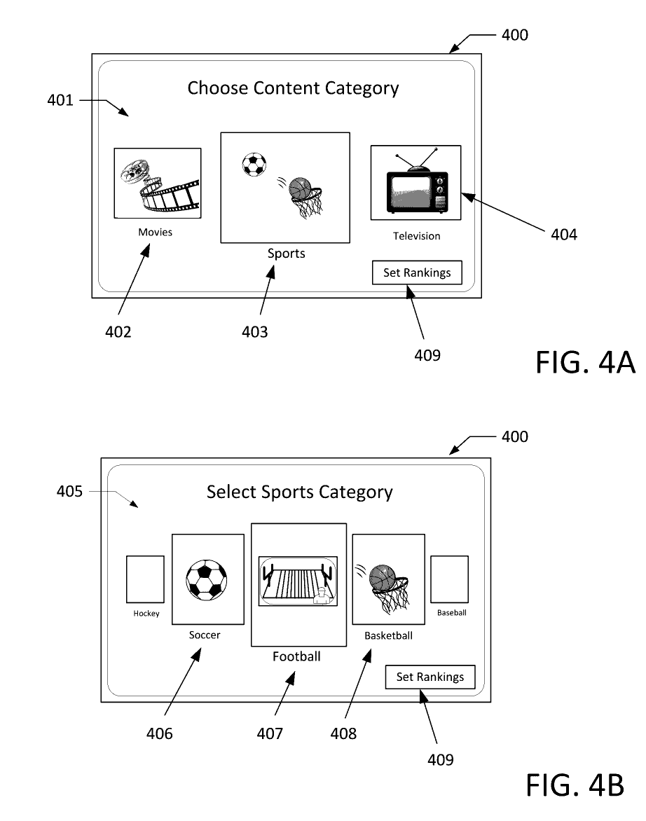

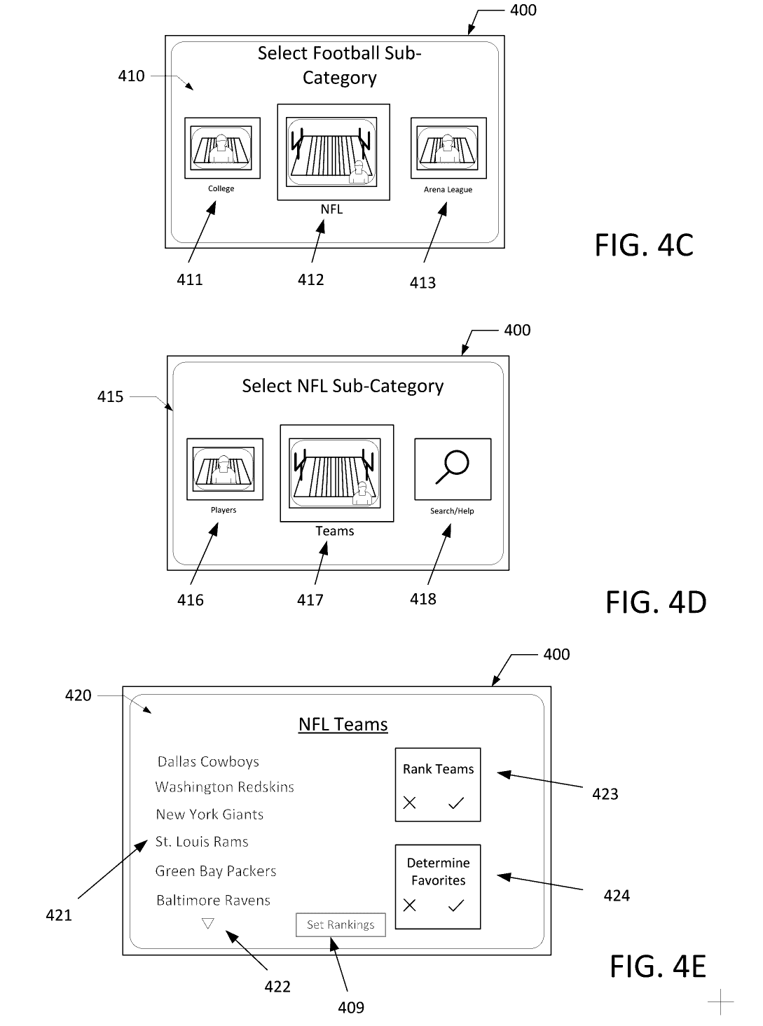

Additionally or alternatively, the user may have the option to provide rankings for a plurality of elements associated with content categories and/or sub-categories. For example, as will be discussed in more detail below with respect to FIGS. 4A-E, a user may have the option to select from a variety of content categories (e.g., Sports, Movies, etc.) for which implicit user favorites may be determined by the recommendation system. Additionally or alternatively, a user may establish (or indicate) their content preferences by providing rankings for content categories and/or associated content elements. For instance, within the content category of Sports, a user may have the option to provide rankings for a plurality of available sub-categories (e.g., football, basketball, soccer, etc.).

Various sub-categories (and/or content elements) may be included within one or more content categories without departing from the scope of the present disclosure. For example, the Sports content category may include a plurality of sub-categories such as types of sports (e.g., basketball, football, soccer, etc.), and/or may include a plurality of content elements, such as Sports teams (e.g., Miami Heat, Dallas Cowboys, Real Madrid, etc.), Sports players (e.g., Ronaldo, Dwayne Wade, Tom Brady, etc.), and the like. Additionally or alternatively, each sub-category may include additional sub-categories and/or various other elements associated with and/or relating to the particular sub-category. For example, the basketball sub-category may include multiple sub-categories corresponding to basketball teams and basketball players. A first basketball team sub-category may include a plurality of elements identifying the various basketball teams available for the user to rank. Similarly, a second basketball player sub-category may include a plurality of elements identifying the various basketball players associated with particular basketball teams. One or more consumption or access devices associated with a user may be configured to permit the user to assign rankings to various categories, sub-categories and associated elements as described above. The one or more consumption or access devices associated with the user may also be configured to transmit user rankings to the content provider.

Referring back to step 301, the registration process may also include associating one or more consumption or access devices with a particular user. For example, one or more computing devices at local office 103 may associate device identifiers (e.g., MAC identifiers, IP addresses, and the like) to one or more household or user identifiers. One or more homes may have a unique household identifier. By associating devices with households, the computing device may track content consumption by each household rather than by individual devices within or associated with the household or a particular user. Alternatively, by associating devices with a user identifier or a user account, the computing device may track content consumption for a plurality of users residing in the same household. Accordingly, the computing device may be configured to generate separate content rankings for multiple users within the same household and/or account.

In some embodiments, one or more consumption or access devices may be assigned to a household. For example, a service provider may collect MAC identifiers from various consumption or access devices at a home 102a when one or more consumption or access devices register with a network operated, owned, or managed by the service provider. The service provider may similarly collect IP addresses from consumption or access devices at the home 102a (either at the time of registration or at any other time). Alternatively (or additionally), one or more homes may be assigned a particular set of IP addresses, such as a range of IP addresses (e.g., 123.123.123.001 to 123.123.123.255), a list of specific IP addresses (e.g., 123.123.123.001, 144.123.123.155, and 123.123.123.123), or a combination thereof. The set of MAC identifiers and IP addresses associated with one or more homes may be determined and/or updated at any time. Similarly, if a user logs into his or her user account from an out-of-household location, the user's credentials may be used to identify the user or the user's home 102.

Once a user account is set up, one or more consumption or access devices associated with a user may be configured to receive content items from the content provider so that the remaining steps of FIG. 3A may be performed. In one embodiment, content items may be transmitted to one or more users via an electronic medium. Content items may be provided by any of a variety of transmission methods, e.g., over an electronic network, to one or more user consumption or access devices. For example, content items may be provided by content server 106. The content items may be received by and/or presented on a variety of different types of user devices, such as televisions, set-top boxes, personal computers (e.g., desktop, laptop, and tablet computers, etc.), and mobile devices (e.g., mobile phones, tablet computers, etc.), using various different transmission networks and electronic media (e.g., cable, Internet, wireless, etc.).

For example, one or more content items provided by a content provider may include a sports exhibition, a television program, a movie, or an audio recording transmitted by server 106 at a local or central office 103, over a cable network 101 (e.g., coaxial cables, optical fibers, wireless links, or any combination thereof, etc.). In other examples, the content items may be an Internet (or any packet-switched network) video clip transmitted by a web server to a computing device associated with a user and presented by a browser application during a web browsing session. Other content items may be retrieved and presented to users by software applications executing at gateways and televisions, PCs, mobile devices, or other electronic devices. For instance, mobile applications executing on mobile phones and other devices may be programmed to present content items to users upon the user's request.

During step 301, the system may prompt the user to establish a user profile and/or content preferences for a user account. The system may provide the user with a questionnaire (or other queries) for the purpose of eliciting the user's content preferences. Additionally or alternatively, the user may have the option of selecting (and/or ranking) favorite types of content and/or content items from a list of different content items and content categories. In some aspects of the present disclosure, the user may be prompted to rank various categories of content. The user's preferences and input selections may be processed and stored by the system, for example, in a user profile. Users may access their respective profiles via a user interface, and may adjust any rankings and other content preferences as they desire.

In step 302, the content recommendation system (e.g., one or more computing devices) may retrieve content consumption history data for the requesting user. A content service provider may track and record the consumption history and/or consumption behavior of a user over time. In some embodiments, the recommendation system may retrieve content consumption history data for a user from a computing device at local office 103 (e.g., application server 107). The system may retrieve from memory (or another computing device) information indicating the various content items that have been consumed by a particular user (e.g., the requesting user) or groups of users (e.g., within the same household) over a predetermined period of time (e.g., one month, one year, etc). In some aspects of the present disclosure, a user may provide input to the recommendation system, via a user interface, indicating an amount of time for the predetermined time period. For example, the user interface may include a sliding scale indicating various time periods that a user may select from (e.g., one day to one year; one day to 5 years, etc.).

The content consumption history data retrieved by the system may include information indicating the various categories, sub-categories, and/or elements of content, and the associated content items therein, that have been consumed by the user over time. For example, content consumption history data may include information indicating the content items (and/or the number of content items) within a Sports content category (e.g., number of content items corresponding to sporting events or programming) that have been consumed by a user over a predetermined time period. Additionally, content consumption history data may include information indicating the content items (and/or the number of content items) within a sub-category of Basketball content (e.g., content items corresponding to basketball-related events or programming) that has been consumed by the user over a predetermined time period. Content consumption history data may also include information indicating the content items (and/or the number of content items) associated with elements of a particular category or sub-category. For example, content consumption history data may include information indicating the content items and/or the number of content items featuring a particular basketball team (e.g., Miami Heat), or a particular basketball player (e.g., Dwayne Wade). As noted above, the content consumption history data may also include information identifying a plurality of content elements associated with variety of categories and sub-categories of content (e.g., movies, television shows, comedies, thrillers, drama, etc.) without departing from the scope of the present disclosure.

In some embodiments, the recommendation system may determine that a user has consumed a content item if the user has consumed at least a threshold length of the playing time for the content item. For example, the system may determine that a user has consumed a content item if at least 50% of the content item has been consumed. As another example, the system may determine that a user has consumed a content item if at least 75% of the content item has been consumed. Any desirable threshold may be used by the system to determine whether a content item has been consumed without departing from the scope of the present disclosure.

In step 303, the content recommendation system may determine one or more content categories for which content items in the user's consumption history may be ranked or analyzed. As discussed above, content items may be identified by various categories and/or sub-categories of content. During step 303, a user may determine a particular category and/or sub-category of content that the user wishes to rank and/or determine implicit user favorites. The user may access an interface made available via a display device (e.g., device 112) such that the user may indicate their desired content preferences and selections. The available selection of sub-categories may be restricted based on prior categorical selections made by the user during step 303. For example, after selecting the Sports category, the user may be restricted to one or more sub-categories corresponding to and/or associated with various types of sports content (e.g., basketball, football, soccer, etc.).

In some embodiments, the user interface may comprise a stand-alone software application executing on a user's device, such as smartphone 116, or installed onto a suitable computing device operatively connected to a display device (e.g., display device 112. In other embodiments, the user interface (“UI”) may be component of one or more applications (or services) provided by the content service provider. The user interface may transmit data to the computer device indicating a user's desired content category and/or content sub-category selection. For example, in the instance that a user desires the recommendation system to implicitly determine their favorite basketball teams (and/or determine a ranking of the user's favorite basketball teams), the user may first identify, via the interface, a content category associated with Sports (e.g., the Sports category). Additionally or alternatively, the user may then identify one or more sub-categories within the selected content category. For instance, within the Sports category, the user may be provided, via the user interface, an option for selecting a content sub-category associated with the sport of Basketball. As another example, in the instance that a user desires the recommendation system to implicitly determine their favorite actor in comedic movies (and/or determine a ranking of the user's favorite actors in comedic movies), the user may first identify, via the interface, a content category associated with Movies (e.g., the Movie category). Additionally or alternatively, the user may then identify one or more sub-categories within the selected category. For example, within the Movie category, the user may be provided, via the user interface, an option for selecting a content sub-category associated with Comedies.

FIGS. 4A-E illustrate example interfaces that may be used categories and sub-categories of content, and receive user input indicating desired content selections in accordance with aspects of the disclosure herein. In particular, FIG. 4A illustrates an example UI (i.e., UI 401) that may be displayed on a display of a computing device associated with the user (e.g., touch-sensitive display 400, display of device 112, etc.). As discussed above, a user may navigate through UI display screens to select a particular category and/or sub-category of content to be ranked by the recommendation system. For example, referring to FIG. 4A, a user may navigate a user interface (e.g., UI 401) to select a category and/or sub-category of content to be ranked (and/or analyzed) by the recommendation system as discussed above with reference to step 303 in FIG. 3A.

As discussed above, and as shown in FIG. 4A, content may be classified into various types or categories, such as movies, sports, television programming, and the like. Users may access one or more sub-categories of content relating to a particular content category (e.g., Sports) by selecting sports icon 403 in UI 401. As another example, users may access one or more sub-categories of content relating to Movies by selecting the “movies” icon 402 displayed in UI 401. There are a variety of ways in content may be classified or categorized on the user interface without departing from the scope of the present disclosure. A user may access additional categories of content not currently displayed on a screen of UI 401 by performing one or more predetermined physical gestures on touch-sensitive display 400 (e.g., swipe left, swipe right, etc.).

FIG. 4B illustrates an example of a user interface (e.g., UI 405) that may be displayed on display 400 in response to a user selecting sports icon 403 in UI 401, as described above in conjunction with FIG. 4A. Each category or classification of content may have a plurality of content sub-categories. In this example, UI 405 may present various content sub-categories for the desired category of content selected by the user (e.g., sports-related content). As illustrated in FIG. 4B, available content to be ranked and/or analyzed by the recommendation system may be classified into various types (e.g., subcategories) of sports content, such as basketball, football, soccer, etc. For example, users may access additional content sub-categories (and/or content elements) relating to football by selecting the “football” icon 407 displayed in UI 405. As another example, users may access content sub-categories (and/or content elements) relating to the sport of basketball by selecting the “basketball” icon 408 displayed in UI 405. Each sub-category of sports may be represented by one or more images within a portion of UI 405. A user may access additional types of sports-related sub-categories of content not currently displayed on a screen of UI 405 by performing one or more predetermined physical gestures on display 400 (e.g., swipe left, swipe right, etc.).

As discussed above with respect to step 303, in some aspects of the disclosure, a user may establish default rankings for content categories displayed in an interface. For example, referring to FIG. 4A, a user may select the Set Rankings icon (e.g., icon 409) in interface 401 to access a display screen (or sub-interface) where the user may indicate and/or rank their favorite types of content categories. There are a variety of ways in which the user may indicate and/or rank their favorite types of content without departing from the scope of the present disclosure. For example, the interface may prompt the user to rate each category of content based on a predetermined scale (e.g., number of stars, 0-100, etc.). As another example, the interface may provide the user with a list of content categories and prompt the user to rank each category by associating a value with the category (e.g., associating the number “1” with a content category may indicate the category is ranked first; associating the number “2” with a content category may indicate the category is ranked second, etc.). In some aspects of the present disclosure, the Set Rankings icon 409 may be displayed in other interface display screens such that the user may provide default rankings for various other categories, sub-categories, and/or elements of content. For example, as illustrated in FIG. 4B, a user may select the Set Rankings icon 409 in interface 405 to access a display screen (or sub-interface) where the user may indicate and/or rank their favorite sport content sub-categories (e.g., types of sports).

FIG. 4C illustrates an example of a user interface (e.g., UI 410) that may be displayed in response to a user initiating the selection of football icon 407 in UI 405, as described above in conjunction with FIG. 4B. In this example, UI 410 may present various content sub-categories for the football category of content previously selected by the user. As illustrated in FIG. 4C, available football content to be ranked (and/or analyzed) by the recommendation system may be classified into various types (e.g., subcategories) of football content, such as college football, arena league football, the National Football League, and the like. In some aspects of the present disclosure, users may access additional content sub-categories (and/or content elements) relating to the NFL that may be ranked (and/or analyzed) by the recommendation system by selecting the “NFL” icon 412 displayed in UI 410. Each sub-category of football content may be represented by one or more images within a portion of UI 410. A user may access additional types of football-related sub-categories of content not currently displayed on a screen of UI 410 by performing one or more predetermined physical gestures on display 400 (e.g., swipe left, swipe right, etc.).

FIG. 4D illustrates an example of a user interface (e.g., UI 415) that may be displayed in response to a user initiating the selection of NFL icon 412 in UI 410, as described above in conjunction with FIG. 4C. In this example, UI 415 may present various content sub-categories for the NFL category of content previously selected by the user. As illustrated in FIG. 4D, NFL content to be ranked (and/or analyzed) by the recommendation system may be classified into various types (e.g., elements) of NFL content, such as NFL players, NFL teams, and the like. Users may access the various elements of the “NFL teams” content sub-category that may be ranked (and/or analyzed) by the recommendation system by selecting the “Teams” icon 417 displayed in UI 415. Each sub-category of NFL content may be represented by one or more images within a portion of UI 415. A user may access additional types of football-related sub-categories of content not currently displayed on a screen of UI 415 by performing one or more predetermined physical gestures on display 400 (e.g., swipe left, swipe right, etc.). The various categories, sub-categories, and elements of content available to be analyzed by the system may be presented to the user in various formats without departing from the scope of the present disclosure.

As an additional potential feature, systems, methods, and computer interfaces in accordance with at least some examples of this disclosure may allow a user to get assistance or “on-line help” during the category selection process (e.g., by activating “help” icon 418 in this example interface 415). While any desired information may be provided in response to user interaction with icon 418 of UI 415, in some examples, the UI may display to the user information (e.g., a display of instructions) to assist the user in selecting content categories, sub-categories, and elements. In other aspects of the present disclosure, a user may activate a “search” icon presented in the UI (e.g., UI 415), to browse through and/or search for available categories and sub-categories of content. In some embodiments, by activating the search and/or help icon, the user may access a hierarchal map of the various categories and sub-categories of content that may be analyzed by the recommendation system. Such interface display screens may allow the user to more easily navigate the user interface to selectively identify desired categories, sub-categories, and/or elements of content.

Referring back to FIG. 3A, at step 304, the content recommendation system may determine one or more content elements for a category or sub-category of content that may be ranked by the recommendation system based on the user's content consumption history. As noted above with respect to step 303, the content recommendation system may determine one or more ranking categories, sub-categories, and/or elements based on user selection input. Additionally or alternatively, the content recommendation system determine implicit user favorites from content elements within particular categories and/or sub-categories of content based on a user's content consumption history.

During step 304, the computing device may determine a plurality of content elements associated with the category and/or sub-category of content selected by the user during step 303. For example, as illustrated in FIG. 4E, the user may be provided with a user interface screen, such as user interface screen 420, in response to selecting the NFL team sub-category of content as described above with reference to step 303 and FIG. 4D. As shown in FIG. 4E, a portion 421 of user interface 420 may provide a listing of content elements (e.g., NFL teams) in accordance with the sub-category of content selected by the user. A user may navigate through the UI to view additional elements not currently displayed in UI screen 420 by selecting icon 422. In some embodiments, the user may access a sub-interface that provides the user with an option to rank the elements displayed in the user interface and/or determine user favorites from the content elements displayed in the user interface.

For example, referring to FIG. 4E, the user may cause the system to rank the elements displayed in UI 420 by selecting one or more options presented within sub-interface 423. In some aspects of the present disclosure, selecting the rank feature provided in sub-interface 423 may cause the recommendation system to begin a process of ranking the content elements within a particular category or subcategory of content based on the user's consumption history as described herein. By contrast, selection of the Set Rankings icon 409 may provide an interface display screen (or sub-interface) prompting the user to provide rankings for content elements based on the user's subjective content preferences. Additionally or alternatively, the user may cause the recommendation system to determine implicit user favorites for content elements by selecting one or more options presented within sub-interface 424.

As another example, if the user selects the content sub-category of NBA basketball teams during step 303, the computing device may determine (and/or identify) each of the available content elements (i.e., NBA basketball teams) that may be ranked by the recommendation system. The interface may provide the user with a listing of the elements associated with the desired content sub-category selected by the user. In this example, the interface may provide the user with a listing of NBA basketball teams (e.g., Miami Heat, Dallas Mavericks, etc.) that may be ranked by the system, and/or from which the system may determine implicit user favorites. In some embodiments, the recommendation system may request data from a computing device (e.g., content server) to determine the various content elements for a desired category or sub-category of content.

As yet another example, during step 303, if the user selects the content sub-category corresponding to comedic actors, the computing device may determine (and/or identify) each of the available content elements (i.e., actors in comedic movies) that may be ranked or further analyzed by the recommendation system. The interface may provide the user with a listing of the elements associated with the desired content sub-category selected by the user. In this example, the interface may provide the user with a listing of comedic actors (e.g., Seth Rogen, Bill Hader, etc.) that may be ranked by the system, and/or from which the system may determine implicit user favorites.

Referring back to FIG. 3A, at step 305, the content recommendation system may begin a loop that is performed for the one or more content elements of an identified sub-category of content items determined during step 304. In some embodiments, the system may begin a loop that is performed for one, some, or all of the elements of an identified sub-category of content items that were determined during step 304. At step 306, the content recommendation system may compare a content element within a sub-category of content identified by the user during step 304 with content consumption history data obtained during step 302. In some embodiments, during step 305, the content recommendation system may compare one or more of the content elements determined during step 304 with user consumption history data to determine a number of content items in the user's consumption history featuring and/or associated with said content element. In other embodiments, the computing device may flag (or otherwise identify) the various content items that are associated with and/or feature the content element being analyzed during step 305. In one embodiment, the content recommendation system may store in memory (or some other storage) for later retrieval data indicating the one or more content times that are associated with and/or feature the content element being analyzed during step 305.

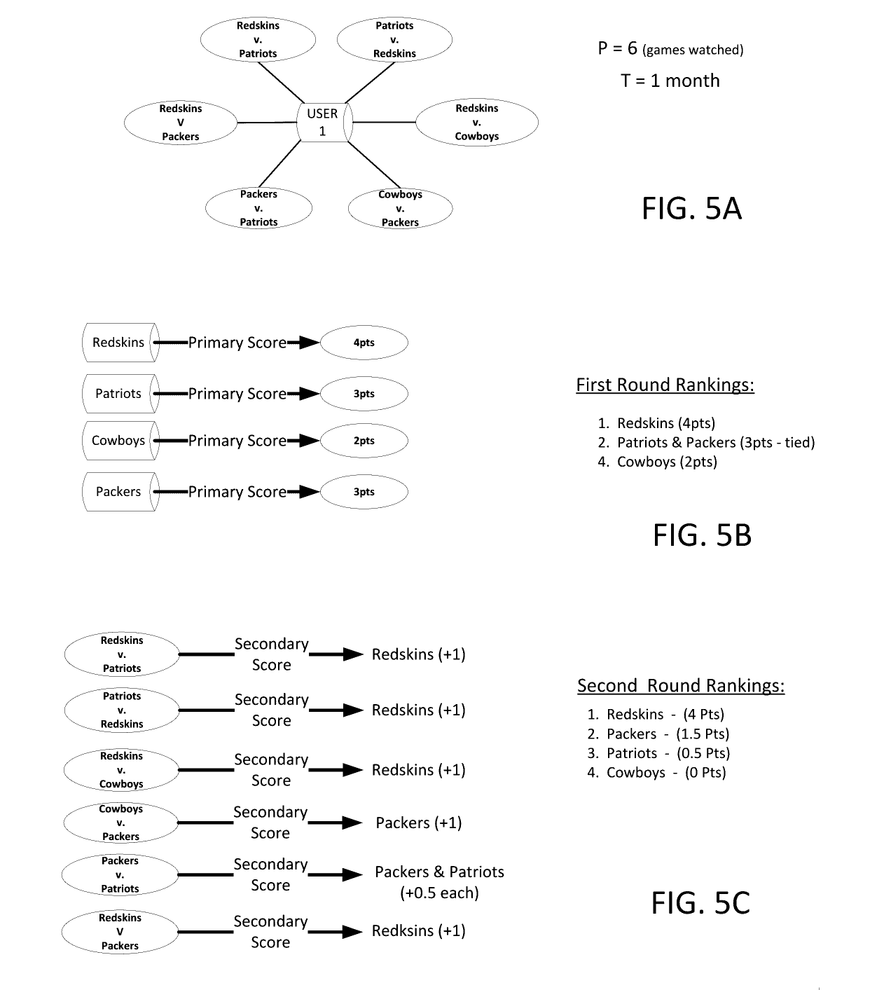

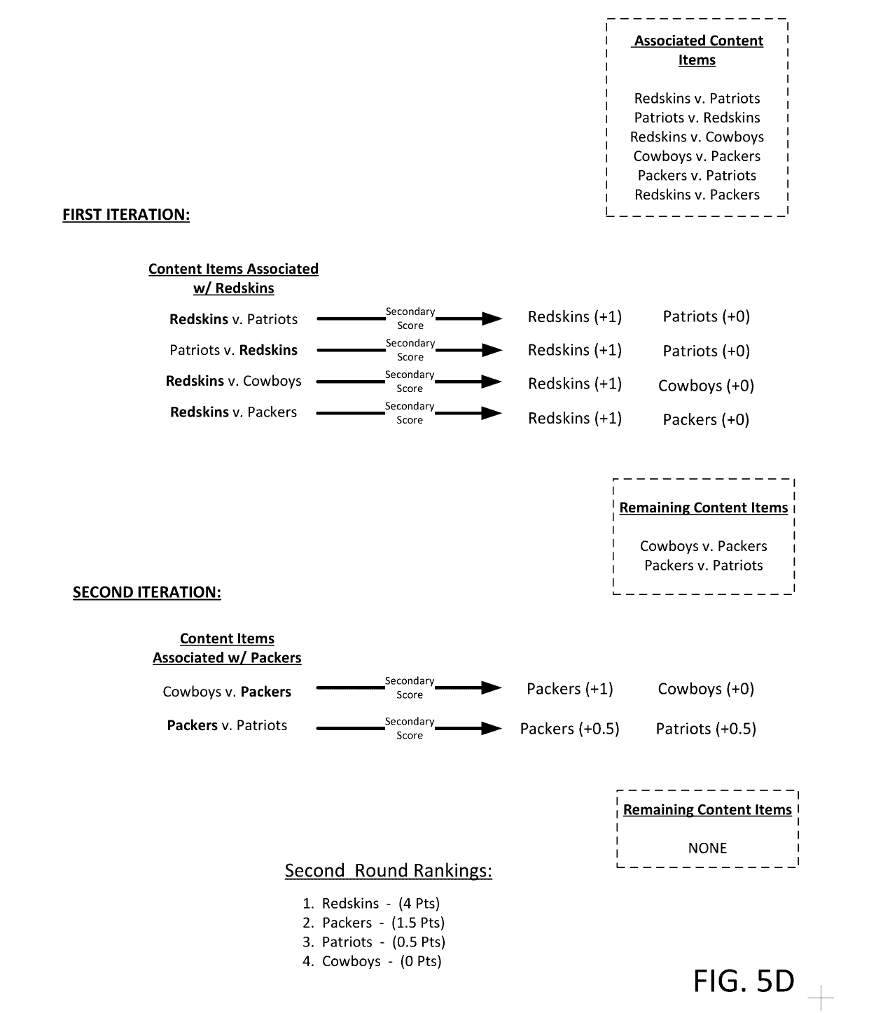

Referring back to the basketball content example discussed above, the content recommendation system may analyze one or more elements corresponding to NBA basketball teams (e.g., Miami Heat) to determine a number of content items in the user's consumption history that are associated with and/or feature said elements. In this example, the recommendation system may determine a number of NBA basketball games featuring the Miami Heat (and/or other NBA teams) that were previously consumed by the user during a predetermined time period (e.g., one year, two years, etc.). Similarly, referring back to the comedic actors example discussed above, the content recommendation system may analyze one or more elements corresponding to comedic actors in Movies (e.g., Seth Rogen) to determine a number of content items in the user's consumption history that are associated with and/or feature said elements. In this example, the computing device may determine a number of comedic movies featuring Seth Rogen (and/or other comedic actors) that were previously consumed by the user during a predetermined time period (e.g., one year, two years, etc.). As yet another example, and as discussed in more detail below with respect to FIGS. 5A-C, in the instance that the user selects a sub-category of content associated with NFL football teams, the recommendation system may analyze one or more elements corresponding to NFL football teams (e.g., Washington Redskins) to determine a number of content items in the user's consumption history that are associated with said elements.

FIG. 5A illustrates example diagrams depicting consumption history information for a user of a content service (e.g., User 1) that has elected to rank elements in the sub-category of content corresponding to NFL football teams. As discussed above, the recommendation system may compare data identifying one or more NFL football teams with a user's consumption history data to determine content items previously consumed by the user over a predetermined time period that are associated with and/or feature NFL football teams or NFL football games. For instance, with respect to the Washington Redskins, the recommendation system may analyze the user's consumption history data to identify any content items (e.g., NFL football games) that feature the Redskins. Various types of content items may be associated with and/or feature the Washington Redskins, such as football game, a documentary, a sports programming show, a news report, etc., without departing from the scope of the present disclosure. The recommendation system may provide the user with an option to select (or narrow) the various types of content that may be included within the corpus of content that may be associated with a particular element. For example, the user may have the option to limit the types of content items to may be associated with the Redskins to football games.

As shown in FIG. 5A, the recommendation system identified four content items (e.g., football games) previously consumed by the user that are associated with and/or feature the Redskins. The recommendation system may perform a similar analysis of the user's consumption history data with respect to the remaining football teams (e.g., content elements) in the subcategory of NFL teams. As shown in FIG. 5A, after analyzing the consumption history data of User 1 with respect to all NFL football teams during the predetermined time period, the recommendation system determined that User 1 consumed six (6) NFL football games involving various football teams over a one-month period of time.

Referring back to FIG. 3A, after the content element being analyzed during loop 305 has been compared to the user's consumption history data, the method may proceed to step 307, where the recommendation system may determine a primary score value for the content element being analyzed during step 305. The primary score for a content element may be determined in a number of ways without departing from the scope of the present disclosure. For example, the primary score for the element may indicate the number of instances that a user has consumed content items associated with and/or featuring the element being analyzed. As another example, the primary score for the element may indicate the number of instances in which content items associated with and/or featuring the element has been consumed (e.g., viewed) by the user within a predetermined time period.

In some aspects of the present disclosure, the recommendation system may determine the primary score value for a content element based on an amount of time a user spent consuming one or more content items associated with and/or featuring said content element. In some embodiments, the primary score for a content element may be determined based on a percentage (%) and/or length of a content item actually consumed by the user. For example, a user who begins consuming a content item, but only consumes half of it, might not have enjoyed the content item. Additionally or alternatively, a user that only consumes half of a content item may not have enjoyed the content item to the same extent as a user who consumed the entire content item. The recommendation system herein may track the user's consumption of a content item, and may record an amount (and/or length) of the content item consumed by the user. In embodiments where the primary score for an element indicates the number of instances that a user has consumed content items associated with and/or featuring the content element, the recommendation system may be configured to adjust the primary score for the content element based on an amount (or percentage) of the content item(s) actually consumed by the user.

Table 1 below shows exemplary primary score values corresponding to different amounts (or percentages) of a content item consumed by a user with respect to various categories (and/or types) of content. As illustrated below, the threshold amounts (or percentages) of a content item consumed by a user may correspond to particular primary score values.

TABLE 1

| | | | Primary Score Value | | | |
|---|---|---|---|---|---|---|
| | | Content Type | 0.25 pt | 0.5 pt | 0.75 pt | 1 pt |
| Amount of | Ex. A | TV | 0-25% | 26-50% | 51-75% | 76%+ |
| Content | Ex. B | Sports | 0-20% | 21-40% | 41-70% | 71%+ |
| Consumed | Ex. C | Movie | 0-15% | 16-25% | 26-49% | 50%+ |

As shown in Table 1, the primary score value assigned a content item may be based on the type of content being consumed by the user and/or an amount of the content item that was consumed by the user. The content consumption threshold values may be processed by the recommendation system to determine primary score values for a content element. Accordingly, rather than assigning a content element the entire primary score value for each content item consumed by a user (notwithstanding an amount of time the user actually spent consuming the content item), the recommendation system may determine a proportionate primary score value for an element in accordance with consumption thresholds (e.g., based on an amount of time the user actually spent consuming the content item).

Table 1 illustrates that in Example B, the recommendation system may determine that when 0-20% of a content item within the content category of Sports has been consumed by the user, the associated element (e.g., the element being analyzed during step 305) may be assigned a primary score value of 0.25 points for that particular content item. Similarly, when 21-40% of the content item has been consumed by the user, the associated element (e.g., the element being analyzed during step 305) may be assigned a primary score value of 0.50 points for that particular content item. As illustrated by Table 1, a user may consume a lesser amount of a movie (e.g., 15%) and the recommendation system may still assign the associated content element a primary score value of 0.25 points. The recommendation system may utilize various content consumption thresholds for various categories (and/or types) of content to determine primary score values for a content element. The recommendation system may retrieve from memory (or another computing device) data indicating consumption thresholds for various categories of content. In some aspects of the disclosure, the user may modify or adjust consumption thresholds utilized by the recommendation system. Adjustments to the consumption thresholds may be stored in memory and/or the user's profile or account.

As discussed above, a higher primary score may indicate a higher level of popularity (or interest) associated with a particular content element in view of the corpus of content items previously consumed by the user. Referring back to the basketball content example discussed above, the recommendation system may determine a primary score value for the Miami Heat based on the number of content items associated with the Miami Heat (e.g., basketball exhibitions featuring the Miami Heat) that were consumed by the user within a predetermined period of time. For example, if the user consumed 15 basketball games featuring the Miami Heat, the recommendation system may assign the Miami Heat a primary score value of 15. As another example, referring to the comedic actor example discussed above, if the user consumed 10 movies featuring the actor Seth Rogen, the recommendation system may assign the content element corresponding to Seth Rogen a primary score value of 10. Additionally or alternatively, the recommendation system may adjust the primary score value for a content element (e.g., Miami Heat, Seth Rogen, etc.) based on an amount of time the user spent consuming content items associated with and/or featuring said element. For instance, in the basketball example above, if the user only consumed half of each of the 15 basketball games featuring the Miami Heat, the primary score value may be adjusted from 15 points to 11.25 points (i.e., 15 games*0.75 pts). By contrast, in the comedic actor example above, if the user consumed half of each of the 10 comedic movies featuring Seth Rogen, the primary score value may not require further adjustments, and Seth Rogen (e.g., content element) may still be assigned a primary score value of 10 (i.e., 10 movies*1 pt).

Referring now to FIG. 5B, the recommendation system may determine a primary score for a content element (e.g., NFL football team) associated with content items in the consumption history of User 1, as discussed above and illustrated in FIG. 5A. In this example, the recommendation system may determine a primary score for an NFL team participating in football games consumed by User 1 during the specified 1 month time period. For instance, the recommendation system may determine a primary score for the Washington Redskins based on the number of content items (e.g. NFL games featuring the Redskins) consumed by User 1 during the specified one month period. As discussed above with respect to step 307, the primary score value for a content element may indicate the number of instances that content items associated with and/or featuring said element have been consumed by the user within the predetermined time period. As shown in FIG. 5B, the recommendation system may assign the Redskins a primary score value of 4 points since User 1 has consumed four content items (e.g., NFL games) during the one-month time period that feature and/or are associated with the Redskins (i.e., Redskins v. Patriots; Redskins v. Packers; Patriots v. Redskins; and Redskins v. Cowboys).

After step 307, the system may return to step 305 to continue the loop until all of the content elements determined during step 304 have been processed, and when all of those elements have been processed, the method may proceed to step 308. At step 308, the recommendation system may rank (and/or sort) the content elements analyzed during step 305 based on their respective primary score values. In some aspects of the present disclosure, the recommendation system may incorporate various user preferences and or default rankings provided by the user when determining a ranking for the content elements analyzed during step 305. There are a variety of ways in which the recommendation system my utilize user preferences to adjust content rankings without departing from the scope of the present disclosure. For example, the recommendation system may retrieve default rankings of NFL teams from a user's profile, and use these rankings to adjust the rankings for content elements as determined by the recommendation system using primary score values. As another example, the recommendation system may generate (or adjust) rankings for content elements using a weighted average of content rankings determined based on primary score values and/or default rankings submitted by the user (or other groups of users). The recommendation system may provide the user with an option for determining an amount of weight to afford each type of ranking (e.g., rankings based on primary score, default rankings, etc.) made available to the user. For example, the user may determine that content rankings created by other users of the content service should receive a relatively low weighting (and/or not be considered at all) by the content recommendation system when generating or adjusting content rankings.

Referring back to FIG. 5B, in this example, the recommendation system has determined primary score values for the remaining NFL teams (e.g., Packers, Patriots, and Cowboys) associated with content items consumed by User 1 during the specified time period. As shown in FIG. 5B, the recommendation system awarded each team a primary score value based upon the number of content items consumed by User 1, respectively, during the specified time period. In this example, the recommendation system assigned the Patriots a primary score value of three points given that User 1 consumed 3 games (e.g., content items) featuring the Patriots during the relevant time period. Similarly, the recommendation system assigned the Packers and the Cowboys primary score values of three points and two points, respectively, based on the consumption history of User 1. Additionally, as shown in FIG. 5B, the recommendation system ranked the four NFL teams in order of descending primary score values. In this example, the Redskins are ranked first since they have the highest primary score value (i.e., 4 points), the Patriots and Packers each having a primary score value of 3 points, are tied for second; and the Cowboys, having the lowest primary score value, are ranked last.

FIG. 3B illustrates an example method of determining user implicit favorites, determining secondary score values for content elements of a category and/or sub-category of content being analyzed by the recommendation system, and for ranking said content elements based on their respective secondary scores (and/or other user preferences) and a user's content consumption history according to one or more illustrative aspects of the disclosure.

At step 310, the recommendation system (e.g., one or more computing devices) may identify a plurality of content items corresponding to the one or more content elements determined during step 304. During step 310, the recommendation system may process the consumption history data obtained during step 302 to determine (and/or identify) the content items consumed by the user that are associated with and/or feature the elements determined during step 304. For example, with respect to a particular element representing an NBA basketball team (e.g., Miami Heat), the recommendation system may process the user's consumption history data to determine (and/or identify) the one or more content items consumed by the user associated with and/or featuring the Miami Heat. In this example, the recommendation system may determine (or identify) each content item (e.g., basketball game) previously consumed by the user that featured the Miami Heat against another opponent in a basketball game. In some embodiments, the recommendation system may retrieve from memory (or some other form of storage) data indicating the various content items in a user's consumption history that are associated with and/or feature a particular content element.

In another embodiment, the recommendation system may associate in a database (or some other storage) a particular content element with each of the corresponding content items that were identified for said element during step 310. Referring back to the example above, in the instance a user selects the sub-category of NBA basketball teams, the population of elements to be ranked may include all 30 basketball teams comprising the NBA. In this example, the recommendation system may process the user's consumption history data and identify a plurality of content items consumed by the user that are associated with and/or feature at least one team of the thirty (30) NBA teams (e.g., content items corresponding to a basketball game featuring an NBA team). For each NBA team, the recommendation system may associate in a database a record of the basketball game(s) (e.g., content items) consumed by the user that feature and/or are associated with the respective NBA team.

At step 312, the recommendation system may begin a loop that is performed for the one or more content items identified during step 310. In some embodiments, the system may begin a loop that is performed for one, some, or all of the content items identified during step 310. At step 314, the recommendation system may retrieve secondary score values for the one or more elements corresponding to and/or associated with the content item being analyzed during step 312. The recommendation system may retrieve from memory (or some other data storage) information indicating the secondary score values for the one or more elements corresponding to and/or associated with the content item being analyzed during step 312. In instances where a content element has not been assigned a secondary score (or a secondary score value has not yet been determined for the element), the recommendation system may assign the element a predetermined secondary score value, such as zero (0) points or some other suitable point value. In other embodiments where an element does not have an assigned secondary score value (or a secondary score value has not yet been determined for the element), the method may skip step 314 and proceed to step 316.

After retrieving the secondary score values for the one or more elements corresponding to the content item being analyzed during step 312, the method may proceed to step 316, where the computing device may increment the secondary score value for the higher-ranked (and/or highest ranked) content element. As discussed above with respect to step 308, the recommendation system may rank content elements based upon primary score values. During step 316, the recommendation system may compare data indicating the primary score values for the one or more elements corresponding to and/or associated with the content item being analyzed during step 315. The computing device may increment, by a predetermined value (e.g., 1 point or some other suitable point value), the secondary score of the content element having the higher (or highest) ranking. In some embodiments where multiple elements have the same primary score value, the computing device may increment the secondary score value of both content elements by the predetermined value (e.g., 1 point). In other embodiments where multiple elements have the same primary score value, the computing device may increment the secondary score value of both elements by a proportion of the predetermined value (e.g., 0.5 points). In some embodiments, the recommendation system may determine which content element should receive an increment in secondary score value based on other criteria and/or or user preferences as described herein.

Referring now to FIG. 5C, the recommendation system may determine a secondary score value for a content element (e.g., NFL football team) associated with and/or featured in content items in the consumption history of User 1. In certain aspects of the disclosure, the recommendation system may determine secondary score values for the one or more elements that were assigned primary score values by the system, as discussed above with respect to FIGS. 3A and 5B. Additionally or alternatively, as discussed above with regards to step 310, the recommendation system may process the consumption history data for User 1 to determine (and/or identify) the one or more content items consumed by User 1 that are associated with and/or feature the content elements (e.g., NFL football teams) previously ranked by the system (e.g., assigned primary score values).

In this example, as shown in FIG. 5A, the recommendation system has identified six NFL games featuring NFL teams previously ranked by the recommendation system. For each identified content item (e.g., NFL game), the recommendation system may increment a secondary score value of the element (e.g., NFL team) featured in and/or associated with the content item having the higher (or highest) primary score value. As an example, for the content item corresponding to the Redskins vs. Patriots football game, the recommendation system may increment the secondary score value for the content element corresponding to the Redskins by 1 point (or some other threshold value) given that the Washington Redskins are ranked higher (e.g., has a higher primary score value) than the Patriots. In some aspects of the present disclosure, the recommendation system may increment the secondary score value for equally ranked elements (e.g., teams) by one-half point or any other suitable threshold point value without departing from the scope of the present disclosure. As an example, for the content item corresponding to the Packers vs. Patriots football game in FIG. 5A, the recommendation system may increment the secondary score value for both the Patriots and the Packers by one-half point since the teams are equally ranked (e.g., have the same primary score value).

Referring now to FIG. 3B, after step 316, the method may return to step 312 to continue the loop until all of the content items identified during step 310 have been processed, and when all of those content items have been processed, the method may proceed to step 318. At step 318, the recommendation system may rank (and/or sort) one or more elements based on their respective secondary score values and/or other criteria. During step 318, the recommendation system may adjust the rankings of identified content elements based upon user content preferences and other criteria. In other embodiments, rankings for content elements may be adjusted based on a total amount of time the user spent consuming content items featuring and/or associated with the respective content element.

For example, a user may desire rank elements (e.g., teams) from various sub-categories (e.g., basketball, football, etc.). Given that a basketball season (82 games) may include more games than a football season (16 games), the number of games (e.g., content items) may not be entirely indicative of a user's interest in a particular sub-category of content. For instance, a user consuming five (5) basketball games for a basketball team may not correspond to or indicate a similar user preference or level of popularity with the user as having consumed 5 football games for a particular football team. Additionally, a user may not have access to content items (e.g., games) for a particular content element (e.g., team). For example, certain sports games (e.g., content items) may not be made available to a user for consumption based on a variety of factors and/or other restrictions (e.g., geographical restrictions, black-out restrictions, etc.). The recommendation system may be configured to retrieve data from a remote system (or computing device) to determine whether and/or which content items are available for consumption by a user of a content service. Accordingly, the recommendation system may adjust the rankings for a content element based on the total percentage of available content items associated with and/or featuring the content element that has been consumed by the user over the predetermined time period.

In some aspects of the present disclosure, the recommendation system may communicate and/or receive data from a computing device (e.g., server) associated with a social networking site and/or status broadcast system such as FACEBOOK or TWITTER. The recommendation system may request various types of data about a user (and/or other users of the social networking site) from the computing device without departing from the scope of the present invention. For example, the recommendation system may request data indicating a number of users on the social networking site indicating a preference or liking for a particular content element. As another example, the recommendation system may request geographic, demographic and other types of data or preferences for one or more users. Additionally or alternatively, the recommendation system may request data indicating a number of users commenting on (and/or a number of published comments made) concerning a particular content element. The recommendation system may utilize the data received from the social networking site to adjust the content rankings for a content element as described in the disclosure herein.

At step 320, the recommendation system may determine user content favorites and/or generate content recommendations. In some embodiments, the recommendation system may determine implicit user content favorites based on rankings of content elements previously determined by the system. In one of these embodiments, the recommendation system may determine a user content favorite for a particular category or sub-category of content based on the highest ranked element for the particular category of content. For example, referring to FIG. 5C, the content element corresponding to the Washington Redskins has been assigned the highest secondary score value, and as such, is ranked first in comparison to other content elements (e.g., football teams) associated with and/or featured in content items consumed by User 1 over a predetermined time period. In this example, the recommendation system may determine that User 1's favorite NFL football team, for the specified time period, is the Washington Redskins. The recommendation system may output for display to the user's display device a message indicating that the Washington Redskins are the user's favorite football team. As will be discussed in more detail below, the recommendation system may utilize information indicating user content favorites to modify a user's electronic program guide, and program listings displayed therein.

In some aspects of the present disclosure the recommendation system may determine which ranked content elements to identify as a user favorite based on absolute thresholds. In one embodiment, the recommendation system may identify a threshold number of highest-ranked elements (e.g., a threshold number of content elements having the highest secondary score values) as implicit content favorites for a user. The recommendation system may receive user input indicating and/or adjusting the threshold number of highest-ranked elements that should comprise a user's content favorites. In another embodiment, the recommendation system may exclude ranked content elements from being identified as a user's implicit content favorite based on threshold secondary score values. For example, the user may identify a minimum secondary score value for an element to be considered (and/or identified as) an implicit content favorite. In other embodiments, the recommendation system may exclude a ranked element from being identified as a user's implicit content favorite based on a threshold number of content items associated with and/or featuring the ranked element that have been consumed by the user. For example, the user may identify a minimum number of content items associated with and/or featuring a content element that should be consumed by a user for the element to be considered (and/or identified as) an implicit content favorite by the recommendations system. As another example, the user may identify a minimum percentage of available content items associated with and/or featuring a content element that need to be consumed by a user for the element to be considered (and/or identified as) an implicit content favorite.

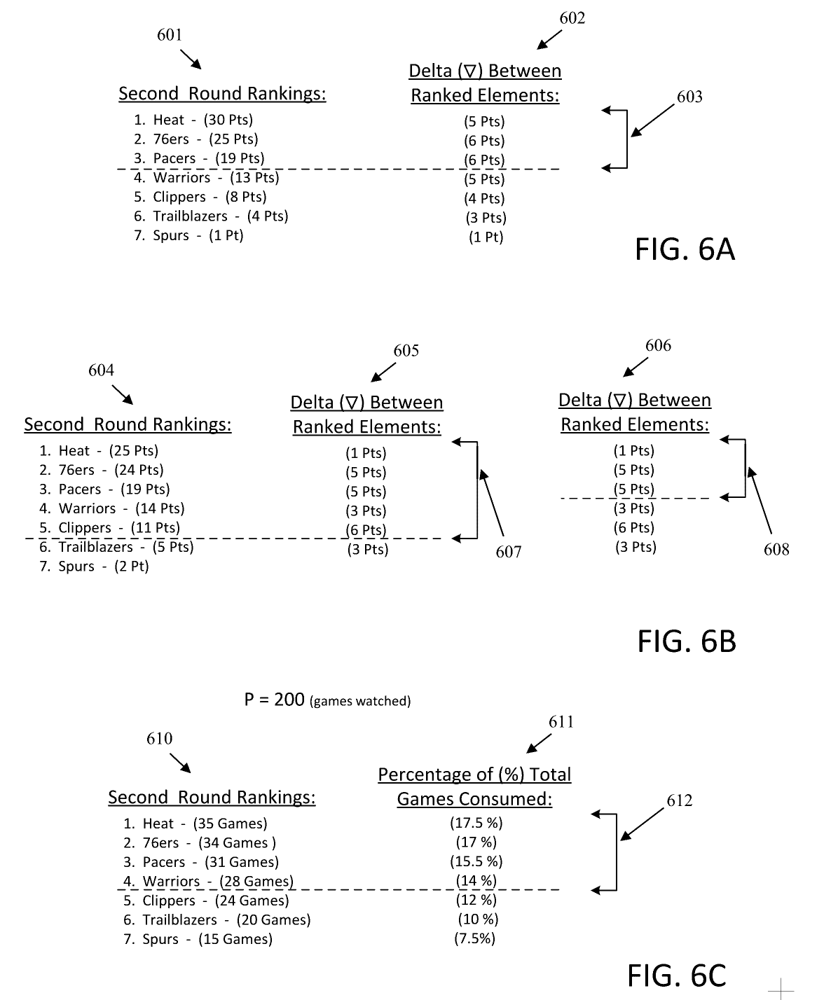

In other aspects of the present disclosure, the recommendation system may determine which ranked content elements to identify as a user content favorite by utilizing relative thresholds. In some embodiments, the recommendation system may analyze a ranking of content elements (e.g., as determined during step 318) and their respective secondary score values to determine a difference (e.g., delta) in secondary score values between ranked element. The recommendation system may determine which ranked content elements to identify as an implicit user favorite based on a threshold difference in secondary score values between ranked content elements. In one of these embodiments, the recommendation system may determine which ranked content elements may be identified as implicit user favorites in accordance with a maximum difference in secondary score values between two ranked elements. For example, as illustrated in FIG. 6A, the recommendation system may analyze the ranking of NBA basketball teams (i.e., element 601), and may determine the maximum difference in secondary score values between each ranked basketball team. In this example, the maximum difference in secondary score values between ranked basketball teams is six (6). Thus, as illustrated by element 603, the recommendation system may identify the three highest ranked teams as the user's favorite basketball teams. As another example, as illustrated in FIG. 6B, the recommendation system may analyze the ranking of NBA basketball teams (i.e., element 604), and may determine the maximum difference in secondary score values between each ranked basketball team. In this example, the maximum difference in secondary score values between ranked basketball teams is six (6). Accordingly, as illustrated by element 607, the recommendation system may identify the five highest ranked teams as the user's favorite basketball teams.

As discussed above with respect to step 310 and FIG. 3B, a content element (e.g., basketball team) may be associated with and/or featured in a plurality of content items (e.g., basketball games, etc.). In some embodiments, the recommendation system may determine which ranked elements to identify as an implicit user favorite by analyzing the number of content items associated with and/or featuring one or more ranked content elements. In one of these embodiments, the recommendation system may configured to determine which basketball teams may be identified as a user's favorite basketball team based on a difference (e.g., delta) in the number of basketball games consumed by the user featuring the ranked elements.

In another of these embodiments, the recommendation system may configured to determine which ranked content elements may be identified as implicit content favorites for a user based on the highest ranked element(s) comprising a threshold proportion of a total number of content items consumed by the user. The recommendation system may determine a predetermined (and/or default) threshold proportion value based on information contained within the user's profile. Additionally or alternatively, the recommendation system may adjust the predetermined threshold proportion value based on user input data. For example, the recommendation system may configured to determine which basketball teams may be identified as a user's favorite basketball team based on the highest ranked basketball teams that comprise a minimum threshold proportion of the total number of basketball games consumed by a user during a predetermined time period.

As illustrated in FIG. 6C, the recommendation system may analyze the ranking of NBA basketball teams (i.e., element 610), and determine which of the highest ranked basketball teams comprise a threshold proportion of the total number of basketball games consumed by the user during the predetermined time period. In this example, the user has consumed 200 basketball games (e.g., content items), and as shown by element 611 in FIG. 6C, the recommendation system may determine the percentage of total basketball games consumed by the user that are associated with each ranked basketball team (e.g., ranked element). For instance, if the minimum threshold proportion of basketball games is set at 51%, as illustrated by element 612 in FIG. 6C, the recommendation system may determine that the four (4) highest ranked basketball teams constitute the minimum threshold of total basketball game consumed by the user, and thus, those teams should be identified as the user's favorite basketball teams.

In some aspects of the present disclosure, during step 320, the recommendation system may generate content recommendations for the user. The content recommendation system may generate content recommendations based on the consumption history of the user requesting content rankings and/or recommendations, the consumption history of one or more other users or groups of users, and/or other user content consumption preferences. In some embodiments, the content recommendation system may determine content recommendations for a user based on content rankings determined during step 318. There are a variety of ways in which the content recommendation system may recommend content items for a user based on previously determined content rankings without departing from the scope of the present disclosure. For example, the content recommendation system may identify one or more content items made available on a content server (and/or by a content provider) that have not yet been consumed by the user, and that are associated with (and/or feature) a ranked content element and/or an element identified by the recommendation system as an implicit user favorite. Referring back to the example in FIG. 5D, the recommendation system may generate a content recommendation to the user based on the Washington Redskins being ranked first. In this example, the recommendation system may recommend content items to the user that are associated with and/or feature the Redskins, such as a football game featuring the Redskins, a documentary about the Redskins, and the like.

In some aspects of the present disclosure, the recommendation system may be operatively connected to and/or configured to communicate with one or more computing devices at local office 103, such as application servers 107. The recommendation system may transmit data to applications servers 107 indicating various user content consumption preferences, such as implicit user favorites (e.g., favorite teams, players, actors, directors, etc.), content rankings, and the like. The application servers 107 at the local office 103 (and/or any other suitable computing device configured to adjust program guide listings or features) may process data received from the recommendation system, and utilize this data to adjust one or more aspects of (and/or program listings information included in) a data download for electronic program guide listings. For example, program listings for content items associated with and/or featuring content elements (e.g., teams, players, actors, etc.) that are ranked and/or have been identified as a user favorite may be emphasized in the electronic program guide display for the user. As another example, program listings for content items that have been recommended to a user by the content recommendation system may similarly be emphasized within the electronic program guide display of the user. There are a variety of ways in which the program guide display may emphasize a particular content item (e.g., program listing) without departing from the scope of the present disclosure. For example, the electronic program guide may display text, graphics, a flag, and/or some other type of indicator, within or near a program listing to visually emphasize that particular listing. As another example, an emphasized program listing may be a different color than other program listings and/or highlighted in the program guide display.

In other aspects of the present disclosure, the program guide may provide the user with an option to filter program listings based on user content preferences, content recommendations, content rankings, and user favorites determined by the recommendation system as described herein. The program guide may also provide the user with an option to record (and/or automatically record) future programming content based on user content preferences and other information received from the content recommendation system. In some embodiments, the program guide may be configured to display pop-up messages on a display device of a user to indicate that programming content featuring and/or associated with a user favorite (and/or are related to other user content preferences) is currently on or will begin shortly. Similarly, the program guide may display reminders indicating that such programming will begin within a predetermined amount of time (e.g., 1 hour, 1 day, etc.). The electronic program guide may provide the user with an option to adjust or modify various preferences (and/or parameters) of the program guide display as described herein.

Referring now to FIG. 3C, in an alternative embodiment, the recommendation system may determine secondary scores values for content elements by iteratively identifying, recording, and/or excluding a population of content items associated with content elements that a user desires to rank and/or from which the user desires to determine content favorites. In this alternative embodiment, the recommendation system may perform one or more of the steps described herein with reference to FIG. 3A. FIG. 3C illustrates this alternative embodiment in detail, and shows an example method of determining secondary score values for content elements and/or ranking said elements based on their respective secondary scores and other user preferences. In this alternative embodiment, after the recommendation system has ranked content elements by primary score values as described with respect to step 308 in FIG. 3A, the recommendation system may perform one or more subsequent rounds of ranking elements associated with and/or featured in content items previously consumed by the user for the purpose of determining a user's implicit content favorites, and/or generating content recommendation based on said user favorites and content rankings.

Referring now to FIG. 3C, at step 330 the recommendation system (e.g., one or more computing devices) may identify a plurality of content items corresponding to the one or more content elements determined during step 304. During step 330, the recommendation system may process the consumption history data obtained during step 302 to determine (and/or identify) the content items consumed by the user that are associated with and/or feature the content elements determined during step 304. In some aspects of the present disclosure, the features and/or processes described above with respect to step 310 may be performed by the recommendation system during step 330. The recommendation system may store in memory the identified content items for later retrieval. In some embodiments, the recommendation system may store the identified content items in a temporary data file, database, and/or other form of storage. In other embodiments, the recommendation system may flag, mark or otherwise distinguish the identified content items from other content items in the consumption history of the user. For example, the recommendation system may assign a unique identifier to the identified content items for the purpose of distinguishing those content items from other content items in the consumption history of the user.

At step 332, the recommendation system may begin a loop that is performed for the one or more content elements determined during step 304. In some embodiments, the system may begin a loop that is performed for one, some, or all of the elements analyzed during loop 305. During loop 332, the recommendation system may analyze content elements in a predetermined order. There are a variety of ways in which the recommendation system may determine the order in which to analyze content elements during loop 332 without departing from the scope of the present disclosure. For example, in some embodiments, the recommendation system may analyze content elements based upon their respective rankings as determined by the system during step 308. For instance, the recommendation system may analyze content elements in order of descending rank. In other embodiments, the recommendation system may analyze elements in order of descending primary score values. In some embodiments, the computing device may associate in a database the content element being analyzed during loop 332 with each of the corresponding content items that were identified for that particular element during step 330.

At step 334, the recommendation system may identify one or more content items associated with and/or featuring the content element being analyzed during loop 332. In some embodiments, during step 334, the recommendation may retrieve from memory (or some other form of storage) data indicating the various content items in a user's consumption history that are associated with and/or feature the content element being analyzed during loop 332. The recommendation system may be configured to determine a number of content items that are associated with and/or feature the content element being analyzed during loop 332. In some aspects of the present disclosure, during step 334, the recommendation system may analyze the identified content items to determine whether said items have previously been flagged, marked or otherwise identified by the recommendation system. For example, as will be discussed in more detail below with respect to step 338, the recommendation system may flag, mark, or otherwise indicate whether associated content items have previously been analyzed by the recommendation system during loop 332. There are a variety of ways in which the system may distinguish between content items and determine whether a content item has previously been analyzed by the system during loop 332 without departing from the scope of the present disclosure. As one example, the system may analyze content items for a unique identifier indicating that the content item has not yet been analyzed by the recommendation system during loop 332.

After the content items associated with the content element being analyzed during loop 332 have been identified, the method may proceed to step 336, where the recommendation system may increment the secondary score value for the content element being analyzed based upon the associated content items identified during step 334. For example, in some aspects of the present disclosure, the recommendation system may increment the secondary score value of a content element based on a number of content items the system identified as being associated with (and/or featuring) the element being analyzed during loop 332. In other embodiments, the recommendation system may increment the secondary score value for a content element by a predetermined value (e.g., 1 point) for each content item identified as being associated with and/or featuring the element being analyzed during loop 332. In other aspects of the present disclosure, the recommendation system may determine (and/or increment) secondary score values for one or more other content elements associated with the content items identified during step 334. In embodiments where a content item is associated with and/or features a second content element having the same ranking as the element being analyzed during loop 332, during step 336, the recommendation system may be configured to increment the secondary score value for the element being analyzed during loop 332 by a portion (and/or fraction) of the predetermined value. For example, the recommendation system may increment the secondary score value of the content element being analyzed during loop 332 by one-half point, rather than one point. Additionally or alternatively, the recommendation system may also increment the secondary score value of the second content element having the same ranking as the element being analyzed during loop 332.

At step 338, the recommendation system may flag, mark, or otherwise indicate that the content items identified during step 334 have been processed (and/or analyzed) by the recommendation system during loop 332. As discussed above, in some aspects of the present disclosure, in subsequent iterations of loop 332 with respect to lower ranked content elements, the recommendation system may disregard (or discount) content items that have already been identified, analyzed, and/or processed by the recommendation system with respect to other elements. During step 338, the recommendation system may flag, mark, or otherwise indicate that one or more content items identified during step 334 that have already been considered, analyzed and/or processed by the recommendation system during loop 332.

After step 338, the method may return to step 332 to continue the loop until all of the content elements analyzed during step 305 (and/or ranked during step 308) have been processed, and when all of those elements have been processed, the method may proceed to step 340, where the system may rank (and/or sort) the content elements analyzed during step 332 based on their respective secondary score values. During step 340, the recommendation system may adjust the rankings for one or more content elements based upon preferences and/or other criteria. In some aspects of the present disclosure, the features and/or processes described above with respect to step 318 may be performed by the recommendation system during step 340. At step 342, the recommendation system may determine implicit user content favorites and/or generate content recommendations. The content recommendation system may generate content recommendations based on the consumption history of the user requesting content rankings and/or recommendations, the consumption history of one or more other users or groups of users, and/or other user content consumption preferences. In some aspects of the present disclosure, the features and/or processes described above with respect to step 320 may be performed by the recommendation system during step 342.

Although example embodiments are described above, the various features and steps may be combined, divided, omitted, rearranged, revised and/or augmented in any desired manner, depending on the specific outcome and/or application. Various alterations, modifications, and improvements will readily occur to those skilled in art. Such alterations, modifications, and improvements as are made obvious by this disclosure are intended to be part of this description though not expressly stated herein, and are intended to be within the spirit and scope of the disclosure. Accordingly, the foregoing description is by way of example only, and not limiting. This patent is limited only as defined in the following claims and equivalents thereto.

We claim:

1. A method comprising:
identifying, by a computing device, a first plurality of content items consumed by a user;
identifying a first plurality of content elements included in a first ranking category;
determining a first ranking for each content element in the first plurality of content elements;
identifying a first set of content items in the first plurality of content items corresponding to the first plurality of content elements;
for each content item in the first set of content items, adjusting a secondary score value for a content element having a highest first ranking;
determining second rankings for each content element in the first plurality of content elements based at least on their respective secondary score value; and
generating a content recommendation for the user based at least in part on the second rankings.

2. The method of claim 1, further comprising:
determining a primary score value for each content element in the first plurality of content elements.

3. The method of claim 2, further comprising:
identifying, in the first plurality of content items consumed by the user, one or more content items featuring at least a first content element in the first plurality of content elements.

4. The method of claim 3, further comprising:
for each content item in the one or more content items:
determining an amount of the content item consumed by the user; and
determining a primary score value for the first content element based at least on a threshold amount of the content item consumed by the user.

5. The method of claim 1, further comprising:
adjusting the second rankings for one or more content elements based at least on content preferences of the user.

6. The method of claim 1, further comprising:
determining implicit content favorites for the user based at least on the second rankings.

7. The method of claim 6, wherein a number of implicit favorites for the user is determined based at least in part on a number of content items in the first plurality of content items.

8. The method of claim 1, wherein the first ranking category comprises team sports.

9. A method comprising:
identifying, by a computing device, a first plurality of content items consumed by a user;
identifying a first plurality of content elements included in a first ranking category;
determining a first ranking for each content element in the first plurality of content elements;
identifying a first set of content items in the first plurality of content items corresponding to the first plurality of content elements;
for each content element in order of descending first ranking:
identifying one or more content items in the first set of content items corresponding to a content element having a highest first ranking;
adjusting a score value for the content element having the highest first ranking in accordance with the one or more content items in the first set of content items;
determining second rankings for each content element in the first plurality of content elements based at least upon their respective score value; and
recommending a first content item for consumption by the user based at least in part on the second rankings.

10. The method of claim 9, further comprising:
outputting for display on a display device at least the first content item.

11. The method of claim 9, further comprising:
enabling the user to interact with a plurality of ranking categories on a user interface.

12. The method of claim 11, further comprising:
receiving, via the user interface, a request for content item recommendations.

13. The method of claim 11, further comprising:
adjusting the second rankings for one or more content elements based at least on data retrieved from a social networking site.

14. A method comprising:
identifying a plurality of content items consumed by a user;
determining a first ranking category;
ranking a first set of content elements according to a predetermined process based at least on a consumption history of the user and the first ranking category;
determining a second set of content elements based at least on a threshold difference in respective secondary score values between one or more ranked content elements in the first set of content elements; and
generating a content recommendation for the user based at least in part on a first content element in the second set of content elements.

15. The method of claim 14, further comprising:
identifying one or more content items featuring at least the first content element.

16. The method of claim 14, further comprising:
adjusting a first aspect of a program listing in an electronic program guide based at least on the content recommendation.

17. The method of claim 16, wherein adjusting the first aspect of the program listing further comprises:
visually emphasizing a representation of the program listing in the electronic program guide.

18. The method of claim 14, wherein determining the first ranking category further comprises:
receiving, via a user interface, user input selection indicating at least a first category of content.

19. The method of claim 14, wherein the first ranking category comprises team sports.

20. The method of claim 14, further comprising:
adjusting rankings for the first set of content elements based at least on content preferences of the user.
